(19) United States
(12) Patent Application Publication
(10) Pub. No.: US 2026/0045399 A1
(43) Pub. Date: Feb. 12, 2026

(54) VIBRATING ACTUATOR FOR USE WITH WEARABLE ELECTRONIC DEVICE

(71) Applicant: Apollo Neuroscience, Inc., Pittsburgh, PA (US)

(72) Inventors: David Mayer Lowell Rabin, Bolton Landing, NY (US); Roger E. Shively, University Place, WA (US); Aureliano Pisa, Richmond Hill (CA); Marc Olivier Chauveau, La Membrolle sur Choisille (FR)

(21) Appl. No.: 19/362,167

(22) Filed: Oct. 17, 2025

Related U.S. Application Data
(63) Continuation of application No. PCT/US2024/025967, filed on Apr. 24, 2024.
(60) Provisional application No. 63/461,469, filed on Apr. 24, 2023.

(51) Int. Cl. H01F 7/20; H01F 7/06; H01F 27/28

(52) U.S. Cl. CPC H01F 7/20; H01F 7/064; H01F 27/28

(57) ABSTRACT

The present disclosure provides a vibrating actuator for use with a wearable electronic device. The vibrating actuator includes a plate of ferritic material situated between two plates of magnetic material, with a conductive coil situated around and electrically insulated from the plate of ferritic material. The three material plates and the coil are encased in a shell that protects and structurally supports the elements of the vibrating actuator such that no adhesive material or any other intervening material is required between the plate of ferritic material and the two plates of magnetic material. Responsive to a control voltage applied to the conductive coil which creates an electromagnetic field, at least one of the material plates is induced into a desired electromechanical response, such as a pattern of vibrations at a preselected frequency, beat, and/or intensity for a preselected duration.

### CLAIM TO PRIORITY

This application claims priority to and is a continuation of International Patent Application Serial No. PCT/US2024/025967, filed on Apr. 24, 2024, now published on Oct. 31, 2024, as WO 2024/226586 (Attorney Docket No. APLO-0015-WO).

International Patent Application Serial No. PCT/US2024/025967 claims priority to U.S. Application Ser. No. 63/461,469, filed Apr. 24, 2023 (Attorney Docket No. APLO-0015-P01).

Each of the foregoing patents and/or applications is incorporated herein by reference in its entirety for all purposes.

### BACKGROUND

Any discussion of the related art throughout this specification should in no way be considered as an admission that such art is widely known or forms part of the common general knowledge in the field.

Vibrating actuators are used in a variety of electronic devices to provide such functionality as haptic feedback, communication, signaling, creation of audio signals, and health benefits. In certain applications, vibrating actuators can be used to provide patterns of vibration to a user in order to selectively stimulate the sympathetic and parasympathetic nervous systems. Such stimulations can be used to treat mental health issues such as anxiety, chronic stress, and PTSD. Within certain applications, a vibrating actuator can be employed in a wearable device and used to apply vibration patterns with a preselected and/or variable frequency, beat, pitch, and/or intensity for a duration to a user's skin. In such applications, these patterns can affect the heart rate variability (HRV) in a user wearing the device in ways conducive to managing such mental health issues.

Significant issues with vibrating actuators, especially as those used with wearable devices, include cost, reliability, and frequency response. These factors are significantly driven by complexity of design.

### SUMMARY

The present disclosure provides a vibrating actuator for use with a wearable electronic device.

In some aspects of the present disclosure, the vibrating actuator may be a linear force actuator and includes a single, contiguous plate of ferritic material situated between two plates of magnetic material, with the ferritic material plate in direct physical contact with the magnetic material plates, substantially free of any intervening material such as adhesive or any dielectric material. Under some aspects of the present disclosure, the vibrating actuator further includes a shell, which encases the material plates, as well as a conductive coil surrounding the perimeter of the plates, providing protection and structural support for the elements of the vibrating actuator.

In some aspects of the present disclosure, the techniques described herein relate to a vibrating actuator that comprises a first plate including a magnetic material situated in a first plane and having a first polarity. Within this aspect of the present disclosure, the vibrating actuator further comprises a second plate including a magnetic material situated in a second plane and having a second polarity, wherein the second plane is situated substantially parallel to and a spaced distance away from the first plane and the first polarity faces the second polarity. Within this aspect of the present disclosure, the vibrating actuator further comprises a third plate, having a perimeter, including a ferritic material situated between the first plate and the second plate and within a first magnetic field created by the first plate and the second plate. Within this aspect of the present disclosure, the vibrating actuator further comprises a conductive coil situated around the perimeter of the third plate, the conductive coil having a first terminal and a second terminal. Within this aspect of the present disclosure, the vibrating actuator further comprises a shell encapsulating the first plate, the second plate, the third plate, and the conductive coil, wherein the shell structurally supports the third plate between and in physical contact with the first plate and the second plate and the conductive coil around the perimeter of at least the third plate. Responsive to an electric current passed through the conductive coil, the conductive coil induces a second magnetic field which induces an electromechanical response in at least one of the first plate, the second plate, or the third plate.

In some aspects, the techniques described herein relate to a vibrating actuator, wherein the first plate and the third plate are in direct physical contact, substantially free of any intervening material, and the second plate and the third plate are in direct physical contact, substantially free of any intervening material.

In some aspects, the techniques described herein relate to a vibrating actuator, wherein the shell holds the first plate and the second plate directly against the third plate.

In some aspects, the techniques described herein relate to a vibrating actuator, wherein the third plate is a single, continuous piece of ferritic material.

In some aspects, the techniques described herein relate to a vibrating actuator, wherein the third plate is substantially free of any gaps, voids, or breaks.

In some aspects, the techniques described herein relate to a vibrating actuator, wherein the first polarity and the second polarity both have a north pole in contact with the third plate.

In some aspects, the techniques described herein relate to a vibrating actuator, further including a first support ring and a second support ring, wherein the first support ring and the second support ring are situated about the conductive coil and structured to hold the conductive coil in position around the third plate.

In some aspects, the techniques described herein relate to a vibrating actuator, wherein the first support ring and the second support ring are plastic.

In some aspects, the techniques described herein relate to a vibrating actuator, wherein the conductive coil is formed from an insulated wire such that the conductive coil is electrically insulated from the first plate, the second plate, and the third plate.

In some aspects, the techniques described herein relate to a vibrating actuator, further including an air gap between the first plate, the second plate, and the third plate, the conductive coil sufficient to prevent electrical contact between the conductive coil and the first plate, the second plate, and the third plate.

In some aspects, the techniques described herein relate to a vibrating actuator, wherein the conductive coil wraps around the perimeter of the third plate a single time to realize a single turn around the third plate.

In some aspects, the techniques described herein relate to a vibrating actuator, wherein the conductive coil wraps around the perimeter of the third plate a plurality of times to realize a plurality of turns around the third plate.

In some aspects, the techniques described herein relate to a vibrating actuator, wherein the conductive coil is a conductive wire wrapped in an insulating material that electrically insulates each turn of the conductive coil from other turns in the conductive coil.

In some aspects, the techniques described herein relate to a vibrating actuator, wherein the shell hermetically seals the first plate, the second plate, and the third plate.

In some aspects, the techniques described herein relate to a vibrating actuator, wherein the shell encapsulating the first plate, the second plate, and the third plate is substantially watertight.

In some aspects, the techniques described herein relate to a vibrating actuator, wherein the first terminal and the second terminal of the conductive coil are accessible from outside of the shell.

In some aspects, the techniques described herein relate to a vibrating actuator, wherein the first terminal and the second terminal of the conductive coil are embedded in and pass through the shell.

In some aspects, the techniques described herein relate to a vibrating actuator, further including a controller circuit and a power source.

In some aspects, the techniques described herein relate to a vibrating actuator, wherein the controller circuit, powered by the power source, is structured to apply a control signal to the first terminal and the second terminal of the conductive coil.

In some aspects, the techniques described herein relate to a vibrating actuator, further including a wireless communication circuit in electrical communication with the controller circuit.

In some aspects, the techniques described herein relate to a vibrating actuator, wherein the power source is a battery.

In some aspects, the techniques described herein relate to a vibrating actuator, wherein responsive to one of a control voltage or a control voltage pattern applied across the first terminal and the second terminal of the conductive coil, at least one of the first plate, the second plate, and the third plate exhibit a desired electromechanical response.

In some aspects, the techniques described herein relate to a vibrating actuator, wherein the desired electromechanical response is at least one of the first plate, the second plate, and the third plate vibrating with at least one of a preselected frequency, a preselected pitch, a preselected beat, a preselected pattern, or a preselected intensity for a preselected duration.

In some aspects, the techniques described herein relate to a vibrating actuator, wherein the desired electromechanical response includes the vibrating actuator vibrating at a frequency within a range of 10 Hz to 300 Hz.

In some aspects, the techniques described herein relate to a vibrating actuator, wherein the vibrating actuator is configured to have a center frequency between 30 Hz and 40 Hz.

In some aspects, the techniques described herein relate to a vibrating actuator, wherein the shell is configured to couple the desired electromechanical response to a material layer in direct physical contact with the vibrating actuator.

In some aspects, the techniques described herein relate to a vibrating actuator, wherein the first plate, the second plate, and the third plate are all one of square-shaped, rectangular-shaped, round-shaped, oval-shaped, or irregularly-shaped.

In some aspects, the techniques described herein relate to a vibrating actuator, wherein responsive to a movement of the third plate due to an external vibration, an electrical current is induced in the conductive coil.

In some aspects of the present disclosure, the techniques described herein relate to a wearable electronic device that comprises a vibrating actuator. Within this aspect of the present disclosure, the vibrating actuator includes a first plate comprised of a magnetic material, situated in a first plane and having a first polarity. The vibrating actuator further includes a second plate comprised of a magnetic material situated in a second plane and having a second polarity. Within this aspect of the present disclosure, the second plane is situated substantially parallel to and a spaced distance away from the first plane and the first polarity faces the second polarity. The vibrating actuator further includes a third plate, having a perimeter, comprised of a ferritic material situated between said first plate and said second plate. The vibrating actuator further includes a conductive coil situated around the perimeter of the third plate. Within this aspect of the present disclosure, the conductive coil has a first terminal and a second terminal. The wearable electronic device further includes a shell encapsulating the first plate, the second plate, the third plate, and the conductive coil. Within this aspect of the present disclosure, the shell provides structural support to hold the third plate between and in physical contact with the first plate and the second plate and the conductive coil around the perimeter of the third plate. The wearable electronic device further includes a power source and a controller circuit powered by the power source. Within this aspect of the present disclosure, the controller circuit is structured to apply at least one of a control voltage or a control voltage pattern across the first terminal and the second terminal of the conductive coil. The wearable electronic device further comprises a strap configured to secure the wearable electronic device to a user and transmit a mechanical vibration from the wearable electronic device to the user. Under this aspect of the present disclosure, responsive to the control voltage applied across the first terminal and the second terminal, the vibrating actuator exhibits a desired electromechanical response realized as a mechanical vibration.

In some aspects, the techniques described herein relate to a wearable electronic device, wherein responsive to one of a control voltage or a control voltage pattern applied across the first terminal and the second terminal of the conductive coil, at least one of the first plate, the second plate, and the third plate exhibit a desired electromechanical response.

In some aspects, the techniques described herein relate to a wearable electronic device, wherein the desired electromechanical response is at least one of the first plate, the second plate, and the third plate vibrating with at least one of a preselected frequency, a preselected pitch, a preselected beat, a preselected pattern, or a preselected intensity for a preselected duration.

In some aspects, the techniques described herein relate to a wearable electronic device, wherein the desired electromechanical response including the vibrating actuator vibrating at a frequency within a range of 10 Hz to 300 Hz.

In some aspects, the techniques described herein relate to a wearable electronic device, wherein the vibrating actuator is configured to have a center frequency between 30 Hz and 40 Hz.

In some aspects, the techniques described herein relate to a wearable electronic device, including: a first module including at least one battery; a second module including a vibrating actuator; a third module, receiving power from the first module and including at least one power and control circuit for providing electrical inputs to the vibrating actuator; a first flexible member connecting the first module and the second module, the first flexible member including electrically conductive elements that provide a first electrical connection between the first module and the second module; and a second flexible member connecting the second module and the third module, the second flexible member including electrically conductive elements that provide a second electrical connection between the second module and the third module; wherein the second module is positioned between the first module and the second module and wherein the first flexible member and the second flexible member have sufficient flexibility to conform to a non-planar surface.

In some aspects, the techniques described herein relate to a wearable electronic device, including: a vibrating actuator, including: a first plate including a magnetic material situated in a first plane and having a first polarity; a second plate including a magnetic material situated in a second plane and having a second polarity, wherein the second plane is situated substantially parallel to and a spaced distance away from the first plane and the first polarity faces the second polarity; a third plate, having a perimeter, including a ferritic material situated between said first plate and said second plate; a conductive coil situated around the perimeter of at least the third plate, the conductive coil having a first terminal and a second terminal; and a shell encapsulating the first plate, the second plate, the third plate, and the conductive coil, wherein the shell structurally supports the third plate between and in physical contact with the first plate and the second plate and the conductive coil around the perimeter of the third plate; wherein, responsive to a control voltage applied across the first terminal and the second terminal, the vibrating actuator exhibits an electromechanical response realized as a mechanical vibration.

In some aspects, the techniques described herein relate to a wearable electronic device, wherein the first flexible member and the second flexible member are configured to isolate the first module and the third module from vibrations generated by the second module.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 is a cross-sectional diagram illustrating an example vibrating actuator according to the present disclosure.

FIG. 2 is a diagram illustrating an isometric cross-sectional view of the example vibrating actuator according to the present disclosure.

FIG. 3 is a diagram illustrating the magnetic flux induced with the ferritic material plate of a vibrating actuator according to the present disclosure when an electrical current is passed through the conductive coil.

FIG. 4 is a block diagram depiction of a wearable electronic device.

FIG. 5 is a cross-sectional diagram illustrating an example vibrating actuator deployed in a device.

FIG. 6 is a cross-sectional diagram illustrating an example vibrating actuator according to the present disclosure.

FIG. 7 is a diagram illustrating an example of a device housing a vibrating actuator.

### DETAILED DESCRIPTION

The present disclosure teaches a vibrating actuator for use with a wearable electronic device. The present disclosure provides, in certain aspects and as described in detail throughout the specification, a vibrating actuator that is mechanically simple, low-cost, and functional in a number of environments—for example, in inclement weather or underwater. In certain aspects, the vibrating actuator of the present disclosure is sealed in an encasing shell and protected from environmental hazards, relatively simple in mechanical operation and fabrication, and provides an improved electromechanical response relative to an applied excitation signal.

As will be explained in detail below within the discussion of the figures, the vibrating actuator of the present disclosure may include a single, continuous plate of ferritic material (e.g., a steel pole piece) situated between two plates of magnetic material and surrounded by a conductive coil, which winds around the perimeter of the ferritic material plate. Within such an arrangement, the magnetic plates induce a first magnetic field across the ferritic material plate. The conductive coil includes a first terminal at the start of the coil and a second terminal at the end of the coil, and these terminals permit an electric current to pass through the conductive coil when a control voltage is applied across the terminals. When such an electric current is passed through the conductive coil, a resulting electromagnetic effect temporarily generates a second magnetic field around the ferritic material plate for the duration of the control voltage, inducing an electromechanical response in the ferritic material plate. Under some aspects of the present disclosure, an electromechanical response is also induced in the two magnetic plates. This electromechanical response comprises the ferritic material plate or both the ferritic material plate and the magnetic plates vibrating with a preselected pitch, frequency, beat, and/or intensity, responsive to the variation of a selected control voltage being applied. When the vibrating actuator of the present disclosure is used within a wearable electronic device, these induced vibrations may be used to generate a transcutaneous vibratory output to a user wearing the device. With the improved arrangement disclosed herein, lower frequency ranges for generated vibrations are possible and the transient response is significantly improved, which results in a user experience of a signal that feels clearer and more defined than vibrations delivered by comparison vibrating actuators lacking the improved arrangement disclosed herein.

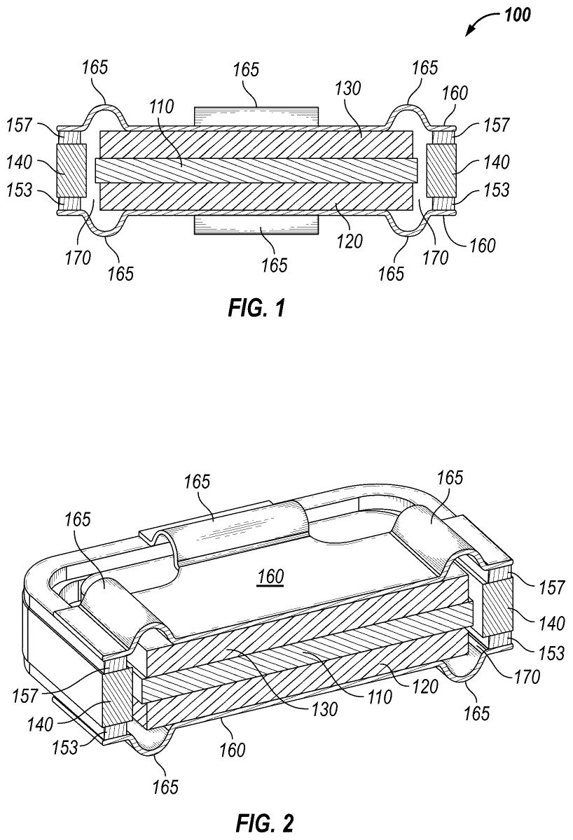

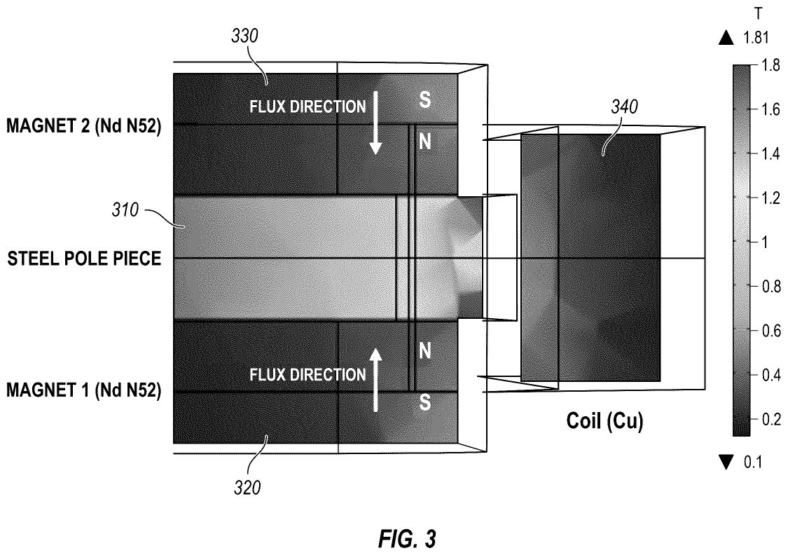

Looking now to FIG. 1, a cross-sectional diagram illustrating an example vibrating actuator 100 according to some aspects of the present disclosure is shown. As shown in FIG. 1, vibrating actuator 100 comprises a ferritic material plate 110 (e.g., a steel pole piece) situated between a first magnetic material plate 120 and a second magnetic material plate 130. As illustrated in FIG. 1, the first magnetic material plate 120 is situated in a first plane, the second magnetic material plate 130 is situated in a second plane substantially parallel to and a spaced distance away from the first plane, and the ferritic material plate 110 is situated between the first and second magnetic material plates 120 and 130, respectively. In some embodiments, the ferritic material plate 110 may be a single, continuous piece of ferritic material, free of gaps, voids, or breaks within the plate. The ferritic material may be formed of stainless steel, carbon steel, nickel, cobalt, or some other ferritic material. The magnetic material forming the magnetic material plates 120 and 130 may be one of alnico, samarium cobalt, ceramic ferrite, neodymium, rubber infused with particles of one or more of these materials, or some other magnetic material. The ferritic material plate 110 and the two magnetic material plates 120 and 130 may be one of substantially square-shaped, substantially rectangular-shaped, substantially round-shaped, or substantially oval-shaped. In other aspects of the present disclosure, the ferritic material plate 110 and the two magnetic material plates 120 and 130 may be irregularly-shaped. As will be discussed in detail with respect to FIG. 3 below, first magnetic material plate 120 and second magnetic material plate 130 may be oriented such that like poles face each other (e.g., either north poles, or south poles), thereby creating a first magnetic field across ferritic material plate 110.

As shown in FIG. 1, the vibrating actuator 100 includes a single, continuous plate of ferritic material 110 (e.g., steel pole piece) situated between a first plate of magnetic material 120 and a second plate of magnetic material 130. In embodiments, the ferritic material plate 110 may include features such as one or more holes in the middle of the plate. This three plate stack is further surrounded by a conductive coil 140, which winds around the perimeter of the ferritic material plate 110. Conductive coil 140 (shown in cross section within FIG. 1) wraps around the perimeter of ferritic material plate 110 and is held in position by lower support ring 153 and upper support ring 157 (both shown in cross section within FIG. 1). Conductive coil 140 may make a single wrap around the perimeter of ferritic material plate 110 to realize a single turn (or wind) around ferritic material plate 110, or it can be a shielded and/or insulated wire that makes a plurality of turns (or winds) around the perimeter of ferritic material plate 110. An air gap 170 may separate the coil electrically and physically from the ferritic material plate 110, first magnetic material plate 120, and second magnetic material plate 130.

In some aspects of the present disclosure, the conductive coil 140 is a single continuous structure made from a conductive material. In other aspects of the present disclosure, the conductive coil 140 is formed using an insulated wire with a solid core. In other aspects of the present disclosure, the conductive coil 140 is formed using an insulated wire with a stranded core. In some aspects of the present disclosure, the vibrating actuator includes an air gap 170 around the perimeter of the ferritic material plate 110 (as shown in FIG. 1), and this air gap 170 provides sufficient insulation to prevent electrical contact between the conductive coil 140 and the ferritic material plate 110 and the two magnetic material plates 120 and 130. In other aspects of the present disclosure, the conductive coil 140 is formed of a conductive element wrapped in an insulating material, which keeps the conductive coil 140 electrically isolated from the ferritic material plate 110 and the two magnetic material plates 120 and 130. The conductive coil 140 may include one of a copper wire, iron wire, gold wire, aluminum wire, silver wire, or alloys thereof.

In some embodiments, the conductive coil 140 includes a first terminal at the start of the conductive coil 140 and a second terminal at the end of the conductive coil 140. These terminals are not shown in FIG. 1. These terminals permit an electric current to pass through the conductive coil 140 when a control voltage is applied across the terminals. Responsive to a control voltage applied across these terminals, this electric current flows through conductive coil 140, around ferritic material plate 110, and results in an electromagnetic effect that temporarily induces a second magnetic field in ferritic material plate 110. This second magnetic field induces an electromechanical response in the ferritic material plate 110. An electromechanical response may also be induced in the two magnetic material plates 120 and 130. The electromechanical response may include the ferritic material plate 110 or both the ferritic material plate 110 and the first and second magnetic plates 120 and 130 vibrating, such as in a desired pattern, responsive to a selected control voltage being applied. By controlling the parameters of the applied control voltage, a desired vibration pattern can be induced within the vibrating actuator 100. Such vibration patterns may be defined by one or more of a frequency, pitch, beat, and/or an intensity. Vibration patterns induced in the vibrating actuator may provide transcutaneous vibratory output to a user wearing a device including the vibrating actuator of the present disclosure. Throughout this disclosure, such transcutaneous vibratory output may be described as having variable parameters comprising a perceived pitch, a perceived beat, and a perceived intensity. Throughout this disclosure, a plurality of perceived pitches, a plurality of perceived beats, and/or a plurality of perceived intensities may be used to generate the transcutaneous vibratory output. Throughout this disclosure, the transcutaneous vibratory output may be generated by multiplicatively combining a sine wave-shaped envelope with a wave pattern having a perceived pitch, such as in accordance with the equation:

[sin (2.0*π*freq_perceived_pitch*t)]*[sin (π*freq_perceived_beat*t)].

Looking now to FIG. 2, the vibrating actuator 100 of FIG. 1 is illustrated in a three-dimensional isometric cross-sectional drawing to better illustrate shell 160 protecting and structurally supporting the elements of the vibrating actuator 100 as well as shaped standoff elements 165. As shown in FIG. 2, shell 160 encases ferritic material plate 110, first magnetic material plate 120, second magnetic material plate 130, conductive coil 140, lower support ring 153, and upper support ring 157. Shell 160 holds ferritic material plate 110, first magnetic material plate 120, and second magnetic material plate 130 tightly together without any gaps between the plates and without the need for any intervening materials such as adhesives. This configuration—a stack of continuous plates, the two outer plates made from a magnetic material and the inner plate made of a ferritic material, without gaps or voids, held together by a shell without intervening material or adhesive—allows for the vibrating actuator to have a configuration such that the vibrating actuator is tunable to a frequency within the range of about 10 Hz to about 300 Hz. Further, such a configuration permits the vibrating actuator of the present disclosure to be structured to have a center frequency (i.e., the frequency in which the vibrating actuator achieves its most efficient operation, which may be the resonant frequency) between 30 Hz and 40 Hz. In some implementations, the actuator may be configured to be structured to have a center between 30 Hz and 45 Hz.

In embodiments, the vibrating actuator is tuned to provide vibrations that have a pitch frequency of 10 Hz to 300 Hz. The pitch frequency may be modulated by an envelope signal, such as a beat frequency. The vibrating motor may be tuned to provide a beat frequency of 0.001 Hz to 300 Hz.

Shell 160 also holds the conductive coil 140 in place with the aid of lower support ring 153 and upper support ring 157, preserving air gap 170 between the conductive coil 140 and ferritic material plate 110, first magnetic material plate 120, and second magnetic material plate 130. As shown in FIG. 2, shell 160 encapsulates and seals the elements of the vibrating actuator, providing both protection and structural support. In some embodiments, shell 160 may completely encapsulate and seal the elements of the vibrating actuator. In other embodiments, shell 160 may surround the elements of the vibrating actuator such as to provide structural support and hold the elements in position without completely encapsulating the elements. Shell 160 may hermetically seal the vibrating actuator components. Within FIG. 2, shaped standoff elements 165 are also visible. These shaped standoff elements 165 are configured to be the contact points between the vibrating actuator and an adjacent material layer against which the vibrating actuator is secured. As discussed in detail above, in certain aspects of the present disclosure, the shaped standoff elements 165 are flexible and function as springs, permitting the vibrating actuator to move up and down as vibrations are induced within ferritic material plate 110, first magnetic material plate 120, and second magnetic material plate 130. In this way, vibration patterns induced in the vibrating actuator are more easily translated into a material layer held adjacent to the vibrating actuator. In certain embodiments, the movement of the vibrating actuator may be substantially similar to the orientation of the poles of or the flux direction in the plates 120, 130.

As discussed above, the ferritic material plate 110, first magnetic material plate 120, and second magnetic material plate 130 are held in place by shell 160, which both protects and provides structural support for the elements of the vibrating actuator. In such an arrangement, the ferritic material plate 110 is in direct physical contact with both of the magnetic material plates 120 and 130 and substantially free of any intervening material between the plates such as, but not limited to, adhesive or dielectric material. That is, in embodiments of the present disclosure, the stack of ferritic material plate 110 and magnetic material plates 120 and 130 may be held together and in position by the shell 160 and may not require any adhesive material between the different plates 110, 120, and 130. Such direct contact between the ferritic material plate 110 and the magnetic material plates 120 and 130, according to the methods of the present disclosure, permits an improved electromechanical response to an applied control voltage as compared to an arrangement wherein, for example, the ferritic material plate 110 and the magnetic material plates 120 and 130 were held together with intervening layers of adhesive. Such direct, unimpeded contact between the ferritic material plate 110 and the magnetic material plates 120 and 130 may allow the ferritic material plate 110 more freedom of movement within the stack of material plates and, as a result, a more effective electromechanical response to a control voltage applied to conductive coil 140.

In some aspects of the present disclosure, shell 160 is gas and liquid impermeable and hermetically seals the vibrating actuator. In other embodiments, shell 160 provides a substantially watertight enclosure around the elements of the vibrating actuator. As described above, the vibrating actuator may further include upper support ring 157 and lower support ring 153 fitted into shell 160 and situated to hold conductive coil 140 in position around the perimeter of ferritic material plate 110. In some aspects of the present disclosure, the first and second terminals of conductive coil 140 pass through shell 160 such that they are accessible from outside shell 160. In some aspects of the present disclosure, the first and second terminals are embedded within shell 160 such that the shell remains at least one of gas impermeable or liquid impermeable while still providing access to the first and second terminals from outside shell 160. In some aspects of the present disclosure, shell 160 further encases a controller circuit and a power supply (both not shown in FIG. 2). The shell 160 may be made of plastic, ceramic, or any material that is both substantially rigid and non-conductive.

In some aspects of the present disclosure, the exterior of shell 160 may be configured to couple an induced electromechanical response within ferritic material plate 110 and/or the two magnetic material plates 120 and 130 into another material held in physical contact with the vibrating actuator. As shown in FIG. 2, shell 160 can include shaped standoff elements 165 configured to transmit transcutaneous vibrations from the vibrating actuator to a user wearing a device including the vibrating actuator. In some aspects of the present disclosure, shell 160 is configured to be worn directly against the skin of a user and couple a desired pattern of vibrations to the user's body with a preselected pitch, frequency, beat, and/or intensity. In other aspects of the present disclosure, shell 160 is configured to be employed within a wearable electronic device and couple a desired pattern of vibrations to material layers within such a wearable electronic device. In some aspects of the present disclosure, shell (or surround) 160 includes a plurality of shaped standoff elements which function as springs when the vibrating actuator is held against another material layer. In certain aspects of the present disclosure, these shaped standoff elements 165 are flexible protrusions that permit the vibrating actuator to oscillate in place as it is activated. In such aspects, this in-place oscillation resulting from the springing effect of the shaped standoff elements 165 aids in coupling the vibration produced within the vibrating actuator to a material layer held adjacent to the vibrating actuator. In certain aspects of the present disclosure, the shell (or surround) 160 and the shaped standoff elements 165 are formed from a single material such as, but not limited to, stainless steel, aluminum, titanium, gold, or any type of metal.

In some aspects of the present disclosure, the vibrating actuator further includes a controller circuit and a power supply. The controller circuit may be one of a microprocessor, a microcontroller, an FPGA, a PLD, an EPROM, an analog circuit, or some combination of analog and digital circuity. The controller circuit, powered by the power supply, provides a control voltage or a control voltage pattern to the first and second terminals of the conductive coil. The controller circuit may be preprogrammed to apply a preselected control voltage or control voltage pattern to the conductive coil. Under other aspects of the present disclosure, the vibrating actuator further includes a wireless communication circuit and, responsive to wireless commands received, the controller circuit applies a control voltage or a control voltage pattern to the conductive coil. The controller circuit may be programmable and/or reprogrammable, with the controller circuit further including a memory circuit capable of storing one or more control voltage patterns. Under some aspects of the present disclosure, the controller circuit can be programmed or reprogrammed via wireless communication from a remote computing terminal. The controller circuit may further include circuitry configured to communicate with a remote computing terminal and provide information such as, but not limited to, power levels, activity logs, identification of stored control voltage patterns, and device operating status. In embodiments, the controller circuit further includes a timing circuit and provides a selected control voltage or a selected control voltage pattern to the conductive coil at preselected times and/or at preselected intervals. The power supply may be a battery, which may be rechargeable via wireless capacitive charging, wireless inductive charging, wired charging, or some combination of these charging methods.

In some aspects of the present disclosure, the control voltage is a DC voltage applied with a selected voltage level for a selected duration. In some embodiments, the control voltage is a waveform with a selected frequency, amplitude, envelope, and duration. In other embodiments, the control voltage is applied at a single frequency. In other aspects of the present disclosure, the control voltage is applied with multiple frequencies, for example, but not limited to, sweeping an applied AC voltage from a first initial frequency to a second end frequency, applying multiple AC voltage signals together wherein each voltage has a different frequency, or applying a first AC voltage at a first frequency then applying a second AC voltage at a second frequency. In some aspects of the present disclosure, the vibrating actuator is tunable to a frequency within the range of about 10 Hz to about 300 Hz. In some aspects of the present disclosure, the vibrating actuator is configured to vibrate at a center frequency (i.e., the frequency in which the vibrating actuator achieves the most efficient operation) that is in between 30 Hz and 40 Hz. In some aspects of the present disclosure, the control voltage is a square wave with a selected amplitude, frequency, duty cycle, and duration. In some aspects of the present disclosure, the control voltage is a control voltage pattern comprising at least one of a preselected series of pulses or a preselected series of analog signals. The conductive coil of the vibrating actuator may be configured to draw on the order of 50 mA when a control voltage is applied. Under some aspects of the present disclosure, a control voltage applied to the terminals of the conductive coil induces an electromechanical response in at least the ferritic material plate resulting from an electromagnetic field created as the control voltage creates an electric current through the coil. Under such aspects of the present disclosure, by applying a specific, preselected control voltage or control voltage pattern to the conductive coil, a desired electromechanical response can be induced within the ferritic material plate alone or within the ferritic material plate and the two magnetic material plates together. Under such aspects of the present disclosure, such a desired electromechanical response can include, but is not limited to, at least one of the ferritic material plate and the two magnetic material plates vibrating with at least one of a preselected frequency, a preselected beat, a preselected pitch, a preselected pattern, or a preselected intensity for a preselected duration.

Referring now to FIG. 3, a magnetic field diagram illustrates the magnetic field induced within ferritic material plate 310 when a control voltage is placed across the terminals of conductive coil 340. Analogous to the arrangement discussed within FIGS. 1 and 2 above, FIG. 3 shows first magnetic material plate 320 situated below ferritic material plate 310 (labeled “steel pole piece” within FIG. 3), and second magnetic material plate 330 situated above ferritic material plate 310. Both first magnetic material plate 320 and second magnetic material plate 330 have their north poles facing ferritic material plate 310, resulting in a first magnetic field with magnetic flux pointing toward the ferritic material plate. With conductive coil 340 energized—that is, with a control voltage applied to the conductive coil 340 creating a current through the coil and around the ferritic material plate 310—a second magnetic field is induced within ferritic material plate 310. As shown in FIG. 3, this second magnetic field is strongest around the perimeter edge of ferritic material plate 310.

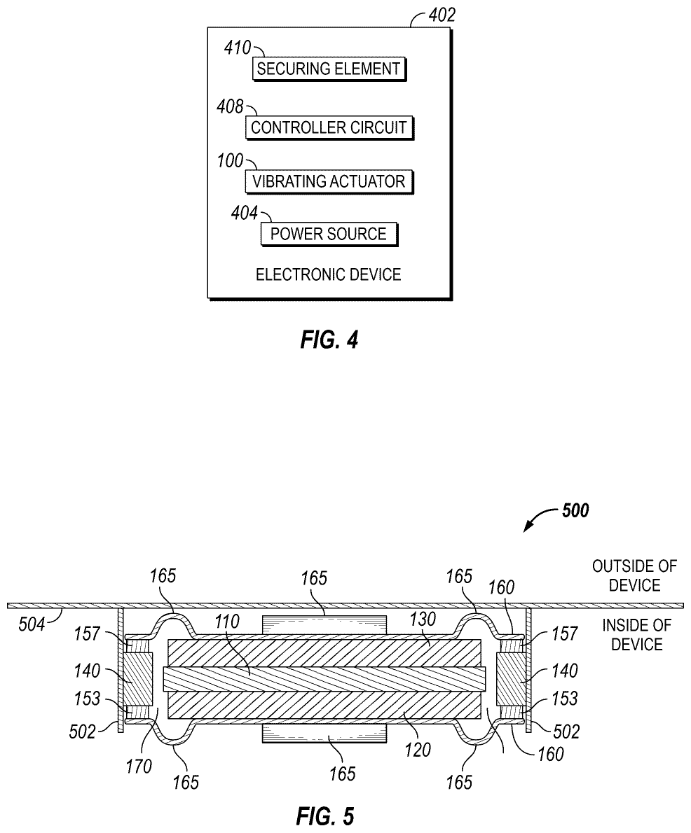

FIG. 4 schematically depicts an embodiment of a wearable electronic device 402. The electronic device 402 includes a vibrating actuator 100. The vibrating actuator 100 includes a first plate comprising a magnetic material situated in a first plane and having a first polarity, a second plate comprising a magnetic material situated in a second plane and having a second polarity, wherein the second plane is situated substantially parallel to and a spaced distance away from the first plane and the first polarity faces the second polarity, and a third plate, having a perimeter, comprising a ferritic material situated between said first plate and said second plate. A conductive coil may be situated around the perimeter of at least the third plate, the conductive coil having a first terminal and a second terminal. A shell may encapsulate the first plate, the second plate, the third plate, and the conductive coil, wherein the shell structurally supports the third plate between and in physical contact with the first plate and the second plate and the conductive coil around the perimeter of the third plate. The device 402 includes a power source 404. A controller circuit 408 may be powered by the power source 404 and structured to apply at least one of a control voltage or a control voltage pattern across the first terminal and the second terminal of the conductive coil. A securing element 410 may be configured to secure the wearable electronic device 402 to a user and transmit a mechanical vibration from the wearable electronic device 402 to the user. Responsive to the control voltage applied across the first terminal and the second terminal, the vibrating actuator 100 exhibits a desired electromechanical response realized as a mechanical vibration.

In some aspects of the present disclosure, a wearable electronic device includes the vibrating actuator of the present disclosure, a controller circuit, a power supply, and a strap, clip, or other securing element configured to secure the wearable electronic device to the user and transmit a mechanical vibration induced within the vibrating actuator to the user. As described in detail throughout the present disclosure, within such aspects the vibrating actuator comprises a ferritic material plate situated between two magnetic material plates, with a conductive coil surrounding the perimeter of the ferritic material plate and having a first and second terminal. Under such aspects, the vibrating actuator is further encased in a shell which provides both protection and structural support for the ferritic material plate, the two magnetic plates, and the conductive coil. Finally, under such aspects, the controller circuit, powered by the power source, is structured to apply a control voltage or a control voltage pattern across the terminals of the conductive coil and thereby induce a desired electromechanical response in the vibrating actuator. Under some aspects of the present disclosure, this electromechanical response is a vibration with at least one of a preselected frequency, a preselected pattern, a preselected pitch, a preselected beat, or a preselected intensity for a preselected duration. In certain aspects of the present disclosure, the electromechanical response is tunable to a frequency range of between 10 Hz and 300 Hz, inclusive, with a center frequency—that is, a frequency wherein the vibrating actuator achieves its most efficient operation—between 30 Hz and 40 Hz, inclusive. Under certain aspects of the present disclosure, the control voltage results in an electrical current on the order of 50 mA through the coil when applied to the coil terminals. In this way, the vibrating actuator of the present disclosure can be used to produce a desired pattern of vibrations useful with a wearable electronic device.

During the operation of the actuator, the actuator provides a displacement of the ferritic material plate 110, first magnetic material plate 120, and second magnetic material plate 130 that is perpendicular to the plane of the ferritic material plate 110, first magnetic material plate 120, and the second magnetic material plate 130. The shape and direction of the displacement of the actuator facilitate a design that can deliver a desired pattern of vibrations into the surface of the skin of a user while the actuator is oriented such that it is positioned flat against a user's skin.

In one implementation, a vibrating actuator suitable for generating vibratory stimulus to a user was constructed with an approximately 17 mm width, 35 mm length, and 5 mm thickness. The implementation has a 113 windings on 8 layers of a 0.14 mm copper with 0.03 mm varnish. The vibratory actuator has a stackup of ferritic material plates with an approximately 30 mm width, 14 mm length, and 3 mm thickness. The air gap between the ferritic material plate and the conductive coil was set to approximately 0.5 mm. The example implementation has a resonant frequency of 42 Hz.

In some instances, a vibrating actuator suitable for generating vibratory stimulus to a user via a wearable device may be less than approximately 5 cm in width and less than 5 cm in length. The actuator may be configured to have a thickness that is less than the width (i.e., less than half the width) such that the actuator is substantially planer.

In embodiments, the operating parameters of the vibrating actuator may be defined by features such as the absolute and relative dimensions of the elements of the vibrating actuator. The operating parameters, such as a center frequency (resonant frequency), amplitude of vibrations, maximum operating frequency, lowest operating frequency, stroke length, energy of vibrations, and the like. Features such as dimensions of elements, relative dimensions of elements, and/or the materials of elements may be selected and modified to tune the operating parameters of the vibrating actuator for specific applications, devices, therapies, and the like. In some cases, modification of one feature (e.g., a dimension of one element) may change more than one operating parameter of the vibrating actuator. In some cases, obtaining the desired operating parameters may require modification of two or more features of the vibrating actuator.

For example, a vibrating actuator may be modified according to the size and/or mass of the device it is integrated with. A device with more mass may require a more powerful actuator to vibrate the mass of the device. The dimensions of the vibrating actuator may be scaled up to achieve the desired energy output.

In another example, operating parameters, such as the frequency response and/or amplitude of vibrations, may be modified by adjusting the thickness of the ferritic material plate 110 and/or the first magnetic material plate 120. Generally, the amplitude of vibrations will increase and the frequency response will decrease as the thickness of the ferritic material plate 110 and/or first magnetic material plate 120 is increased. In embodiments, features such as the volume of the first magnetic material plate 120, the air gap 170 distance to the conductive coil 140, and the material of the first magnetic material plate 120 may be modified to configure the vibrating actuator to the desired operating parameters.

In another example, operating parameters, such as the frequency response and/or amplitude of vibrations, may be modified by adjusting the number of windings of the conductive coil 140. Generally, the amplitude of vibrations will increase and the frequency response will decrease as the number of windings of the conductive coil 140 is increased. In embodiments, features such as the gauge and/or the type of material of the conductive coil 140, the tightness of the windings of the conductive coil 140, and the like may be modified to configure the vibrating actuator to the desired operating parameters.

In another example, operating parameters, such as the frequency response and/or amplitude of vibrations, may be modified by adjusting the shape, thickness, and/or material of the shell 160. In embodiments, the flexibility of the shell 160 may be modified by changing the shape, thickness, and/or the material type of the shell 160. The flexibility of the shell may affect the resistance the shell provides to the movement of the ferritic material plate 110.

In embodiments, the stroke (or throw) may be customized by adjusting the coil/magnet and the rubber surround. In some embodiments, a larger overall height and surface area with larger magnet and more coil windings may allow for achievement of lower frequencies. Conversely, the motor can be reduced in size or designed for more or less energy consumption and/or tuned for higher frequencies.

Looking now to FIG. 5, a cross-sectional diagram is illustrating an example vibrating actuator 500 deployed in a device. FIG. 5 shows a partial cross-section of a device. The device may include a device housing 504 comprising a rigid or semi-rigid material. The device housing 504 may include one more protrusions 502 or features configured to hold the vibrating actuator. In one example, the one more protrusions 502 may be in contact with the upper support ring 157 and/or the lower support ring 153 of the vibrating actuator. One or more protrusions 502 may be configured to hold the upper support ring 157, lower support ring 153, and the conductive coil 140 immobile with respect to the device housing 504. During the operation of the vibrating actuator, the ferritic material plate 110, the second magnetic material plate 130, and the first magnetic material plate 120 vibrate with a displacement direction that is perpendicular to the device housing 504. The shaped standoff elements 165 may touch or rest against the device housing 504. In some implementations, an air gap may be between the shaped standoff elements 165 and the device housing 504. During the operation of the vibrating actuator, the movement of the second magnetic material plate 130, first magnetic material plate 120, and ferritic material plate 110 may cause the device housing 504 and/or the device to vibrate according to the signals provided to the terminals of the conductive coil 140. In embodiments, the outer surface of the device housing 504 may be configured to be positioned against a body part, thereby transferring the vibrations to a user.

The dimensions of the actuator and the direction of actuation facilitate the integration of the actuator into a flat device. The actuator may be positioned into a flat or low profile enclosure or other device that is positioned against a user's skin. The direction of the actuation of the actuator enables the generation of vibrations from the device that are perpendicular to the surface of the skin. A direction of actuation that is perpendicular to the surface of a user's skin enables improved energy transfer of the vibrations to the user. A direction of actuation that is perpendicular to the surface of a user's skin enables the actuator to deliver vibrations and stimulation to a user at a lower power level compared to other configurations.

In embodiments, the device housing 504 may include an area comprising flexible material above the vibrating actuator between the one more protrusions 502. The flexible material may be configured to flex and/or move to transfer vibrations from the vibrating actuator. The flexible material may allow transfer or vibrations to a user without requiring the vibration of the whole device. In embodiments, an enclosure with flexible materials may include other flexible areas or air valves to compensate for pressure changes inside the device housing, as flexible materials are deformed by the movement of the actuator during operation.

In some implementations, the device housing may include a combination of rigid, semi-rigid, and flexible materials. Semi-rigid and flexible materials may arranged on the device housing to attenuate high frequencies (such as unwanted harmonics) during the operation of the actuator. In one example, semi-rigid and/or flexible materials may be added to the area of the device that is in contact with the user's skin to attenuate unwanted higher frequencies (such as frequencies over 5 KHz). In another example, semi-rigid and/or flexible materials may be included in one or more protrusions 502 to isolate the actuator from the rest of the device housing. In embodiments, semi-rigid and/or flexible materials may include silicon, rubber, or other like materials.

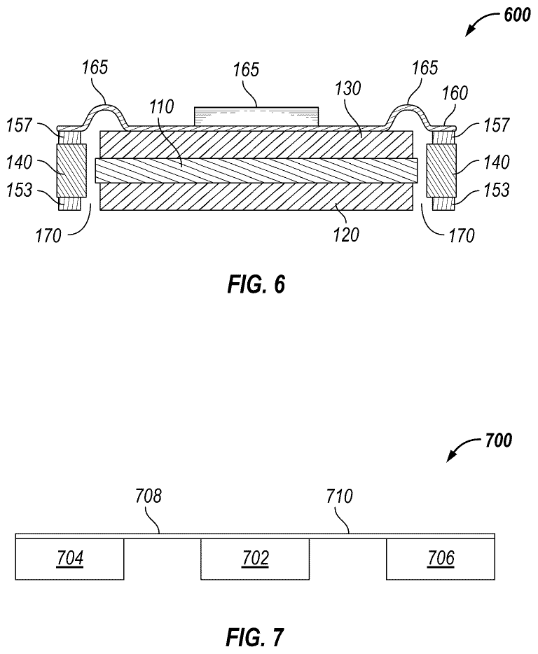

Looking now to FIG. 6, a cross-sectional diagram illustrating another example vibrating actuator 600 according to some aspects of the present disclosure is shown. In some implementations, the vibrating actuator may not be symmetric in structure. The example of FIG. 6 shows one variation where the shell 160 with the shaped standoff elements 165 are only on one side of the vibrating actuator. In embodiments, shell 160 may be configured to attach to the second magnetic material plate 130 and provide the necessary constraints for the linear movement in the vibrating actuator. In some embodiments, opposite sides of the vibrating actuator may include different shells that comprise different materials, elasticity, thicknesses, shapes, and the like. The different shells on the opposite sides of the actuator may cause non-symmetric behavior in the movement of the elements of the actuator depending on the differences between the shells of the actuator.

In some aspects of the present disclosure, a control voltage applied to the terminals of the conductive coil induces an electromechanical response. In some implementations, the control voltage may be a sinusoidal wave, a square wave, a trapezoidal signal, an impulse, and the like. In some situations, the control voltage may oscillate in polarity, causing an alternating current in the conductive coil. The alternating current may, therefore, cause alternating electromechanical force that forces the ferritic and magnetic plates in both positive or negative directions from their nominal positions according to the polarity of the control voltage. For some implementations or applications, the control voltage may be a direct current wherein the polarity of the inputs does not change as the voltage changes. A direct current may cause an electromechanical force in one direction, causing movement of the ferritic and magnetic plates toward one side from their nominal positions.

In some aspects of the present disclosure, the vibrating actuator may be used as a microphone or a sensor to detect vibrations. A vibration applied to the actuator may cause a movement of the first magnetic and ferritic plates in relation to the conductive coil. The movement may induce a current in the coil which may be detected by an appropriate circuit. The functionality of the vibrating actuator may be changed from generating vibrations to detecting vibrations by selecting the appropriate circuitry connections at the terminals of the conductive coil.

Looking now to FIG. 7, a diagram illustrating another example vibrating actuator deployed in a device is shown. In some implementations, a vibrating actuator may be deployed in a device that separates elements into separate modules connected by flexible members. In one example, a device 700 may include three modules with two flexible members 708 and 710. In one example, one of the modules may include an electronics and circuit module 704 that houses one or more power electronics, microcontrollers, memory, communication circuitry, and the like. The device may further include a vibrating actuator module 702 that houses one or more of the vibrating actuators described herein. The device may further include a power module 706 that houses a power supply such as a battery. The modules may be physically and electrically connected via flexible members 708 and 710. The flexible members may include one or more electrically conductive elements to provide power and/or communications between the modules. The flexible members 708 and 710 allow the device 700 to bend and change shape and to conform to a user's body parts that may be non-planar. The configuration of the device 700 provides a flat design that can be worn on the body with minimal protrusions. In embodiments, the device may include any number of additional modules connected with flexible members housing additional electronics, vibrating actuators, power sources, and the like. The separation of the vibrating actuator module 702 by flexible members decouples other modules from the vibrations, which may improve the longevity of the device and require a smaller vibrating actuator as the vibrating actuator may couple to a smaller mass than if all the elements of the device were included in one module.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the scope of the present disclosure is not to be limited by the foregoing examples, but is to be understood in the broadest sense allowable by law.

1. A vibrating actuator, comprising:
a first plate comprising a magnetic material situated in a first plane and having a first polarity;
a second plate comprising a magnetic material situated in a second plane and having a second polarity, wherein the second plane is situated substantially parallel to and a spaced distance away from the first plane and the first polarity faces the second polarity;
a third plate, having a perimeter, comprising a ferritic material situated between the first plate and the second plate and within a first magnetic field created by the first plate and the second plate;
a conductive coil situated around the perimeter of the third plate, the conductive coil having a first terminal and a second terminal;
a shell encapsulating the first plate, the second plate, the third plate, and the conductive coil, wherein the shell structurally supports the third plate between and in physical contact with the first plate and the second plate and the conductive coil around the perimeter of at least the third plate; and
wherein responsive to an electric current passed through the conductive coil, the conductive coil induces a second magnetic field which induces an electromechanical response in at least one of the first plate, the second plate, or the third plate.

2. The vibrating actuator of claim 1, wherein the first plate and the third plate are in direct physical contact, substantially free of any intervening material, and the second plate and the third plate are in direct physical contact, substantially free of any intervening material.

3. The vibrating actuator of claim 1, wherein the shell holds the first plate and the second plate directly against the third plate.

4. The vibrating actuator of claim 1, wherein the third plate is a single, continuous piece of ferritic material.

5. The vibrating actuator of claim 4, wherein the third plate is substantially free of any gaps, voids, or breaks.

6. The vibrating actuator of claim 1, wherein the first polarity and the second polarity both have a north pole in contact with the third plate.

7. The vibrating actuator of claim 1, further comprising a first support ring and a second support ring, wherein the first support ring and the second support ring are situated about the conductive coil and structured to hold the conductive coil in position around the third plate.

8. The vibrating actuator of claim 7, wherein the first support ring and the second support ring are plastic.

9. The vibrating actuator of claim 1, wherein the conductive coil is formed from an insulated wire such that the conductive coil is electrically insulated from the first plate, the second plate, and the third plate.

10. The vibrating actuator of claim 1, further comprising an air gap between the first plate, the second plate, and the third plate, the conductive coil sufficient to prevent electrical contact between the conductive coil and the first plate, the second plate, and the third plate.

11. The vibrating actuator of claim 1, wherein the conductive coil wraps around the perimeter of the third plate a single time to realize a single turn around the third plate.

12. The vibrating actuator of claim 1, wherein the conductive coil wraps around the perimeter of the third plate a plurality of times to realize a plurality of turns around the third plate.

13. The vibrating actuator of claim 12, wherein the conductive coil is a conductive wire wrapped in an insulating material that electrically insulates each turn of the conductive coil from other turns in the conductive coil.

14. The vibrating actuator of claim 1, wherein the shell hermetically seals the first plate, the second plate, and the third plate.

15. The vibrating actuator of claim 1, wherein the shell encapsulating the first plate, the second plate, and the third plate is substantially watertight.

16. The vibrating actuator of claim 1, wherein the first terminal and the second terminal of the conductive coil are accessible from outside of the shell.

17. The vibrating actuator of claim 1, wherein the first terminal and the second terminal of the conductive coil are embedded in and pass through the shell.

18. The vibrating actuator of claim 1, further comprising a controller circuit and a power source.

19. The vibrating actuator of claim 18, wherein the controller circuit, powered by the power source, is structured to apply a control signal to the first terminal and the second terminal of the conductive coil.

20. The vibrating actuator of claim 18, further comprising a wireless communication circuit in electrical communication with the controller circuit.

21. The vibrating actuator of claim 18, wherein the power source is a battery.

22. The vibrating actuator of claim 1, wherein responsive to one of a control voltage or a control voltage pattern applied across the first terminal and the second terminal of the conductive coil, at least one of the first plate, the second plate, and the third plate exhibit a desired electromechanical response.

23. The vibrating actuator of claim 22, wherein the desired electromechanical response is at least one of the first plate, the second plate, and the third plate vibrating with at least one of a preselected frequency, a preselected pitch, a preselected beat, a preselected pattern, or a preselected intensity for a preselected duration.

24. The vibrating actuator of claim 22, wherein the desired electromechanical response comprising the vibrating actuator vibrating at a frequency within a range of 10 Hz to 300 Hz.

25. The vibrating actuator of claim 1, wherein the vibrating actuator is configured to have a center frequency between 30 Hz and 40 Hz.

26. The vibrating actuator of claim 22, wherein the shell is configured to couple the desired electromechanical response to a material layer in direct physical contact with the vibrating actuator.

27. The vibrating actuator of claim 1, wherein the first plate, the second plate, and the third plate are all one of square-shaped, rectangular-shaped, round-shaped, oval-shaped, or irregularly-shaped.

28. The vibrating actuator of claim 1, wherein responsive to a movement of the third plate due to an external vibration, an electrical current is induced in the conductive coil.

29. A wearable electronic device, comprising:
a vibrating actuator, including:
a first plate comprising a magnetic material situated in a first plane and having a first polarity;
a second plate comprising a magnetic material situated in a second plane and having a second polarity, wherein the second plane is situated substantially parallel to and a spaced distance away from the first plane and the first polarity faces the second polarity;
a third plate, having a perimeter, comprising a ferritic material situated between said first plate and said second plate;
a conductive coil situated around the perimeter of at least the third plate, the conductive coil having a first terminal and a second terminal; and
a shell encapsulating the first plate, the second plate, the third plate, and the conductive coil, wherein the shell structurally supports the third plate between and in physical contact with the first plate and the second plate and the conductive coil around the perimeter of the third plate;
a power source;
a controller circuit powered by the power source and structured to apply at least one of a control voltage or a control voltage pattern across the first terminal and the second terminal of the conductive coil;
a securing element configured to secure the wearable electronic device to a user and transmit a mechanical vibration from the wearable electronic device to the user; and
wherein, responsive to the control voltage applied across the first terminal and the second terminal, the vibrating actuator exhibits a desired electromechanical response realized as a mechanical vibration.

30. The wearable electronic device of claim 29, wherein responsive to one of a control voltage or a control voltage pattern applied across the first terminal and the second terminal of the conductive coil, at least one of the first plate, the second plate, and the third plate exhibit a desired electromechanical response.

31. The wearable electronic device of claim 30, wherein the desired electromechanical response is at least one of the first plate, the second plate, and the third plate vibrating with at least one of a preselected frequency, a preselected pitch, a preselected beat, a preselected pattern, or a preselected intensity for a preselected duration.

32. The wearable electronic device of claim 30, wherein the desired electromechanical response comprising the vibrating actuator vibrating at a frequency within a range of 10 Hz to 300 Hz.

33. The wearable electronic device of claim 29, wherein the vibrating actuator is configured to have a center frequency between 30 Hz and 40 Hz.

34-36. (canceled)
